(19) United States
(12) Patent Application Publication
(10) Pub. No.: US 2025/0215962 A1
(43) Pub. Date: Jul. 3, 2025

(54) BALL SCREW UNIT, SLIDER UNIT, AND REGULATING UNIT

(71) Applicant: HIRATA CORPORATION, Kumamoto-shi (JP)

(72) Inventor: Bungo MATSUMOTO, Kumamoto-shi (JP)

(73) Assignee: HIRATA CORPORATION, Kumamoto-shi (JP)

(21) Appl. No.: 19/084,942

(22) Filed: Mar. 20, 2025

Related U.S. Application Data
(63) Continuation of application No. PCT/JP2022/038262, filed on Oct. 13, 2022.

(51) Int. Cl. F16H 25/24; F16H 25/22

(52) U.S. Cl. CPC F16H 25/2454; F16H 25/2204

(57) ABSTRACT

A ball screw unit is attached to a screw shaft. The unit includes a moving body configured to be movable in an axial direction of the screw shaft in conjunction with relative rotation with the screw shaft, and a regulating mechanism configured to regulate the relative rotation of the screw shaft and the moving body. The regulating mechanism includes a nut to be screwed into the screw shaft, a biasing member configured to bias the nut in the axial direction so as to generate a frictional force between the nut and the screw shaft, a housing configured to be detachably connected to the moving body and accommodating the nut and the biasing member, and a regulating member provided in the housing and configured to regulate relative rotation of the nut with respect to the housing.

### CROSS-REFERENCE TO RELATED APPLICATION(S)

This application is a Continuation of International Patent Application No. PCT/JP2022/038262, filed Oct. 13, 2022, the entire disclosures of which is incorporated herein by reference.

### BACKGROUND OF THE INVENTION

### Field of the Invention

The present invention relates to a ball screw unit, a slider unit, and a regulating unit.

### Description of the Related Art

Ball screws are known as a mechanism for converting rotational motion into linear motion. Ball screws can be provided with a mechanism that generates a force (braking force) against movement of a ball nut (for example, Japanese Unexamined Utility Model Application Publication No. 59-144253), in order to control free fall when a screw shaft is disposed in the vertical direction or inertial motion when a screw shaft is disposed in the horizontal direction.

In the above conventional technique, a force against movement of a ball nut is generated by pressing a protrusion of a piston against a screw groove of a screw shaft using an air compressor. However, in the above conventional technique, there is a risk that the mechanism becomes larger due to the use of the air compressor. In addition, the structure for attaching the piston to the ball nut becomes complicated, which may affect manufacturing costs and the like.

### SUMMARY OF THE INVENTION

The present invention provides a mechanism that generates a force against movement of a ball nut with a simpler configuration.

According to the present invention, there is provided a ball screw unit configured to be attached to a screw shaft, comprising: a moving body configured to be movable in an axial direction of the screw shaft in conjunction with relative rotation with the screw shaft; and a regulating mechanism configured to regulate the relative rotation of the screw shaft and the moving body, wherein the regulating mechanism includes: a nut to be screwed into the screw shaft; a biasing member configured to bias the nut in the axial direction so as to generate a frictional force between the nut and the screw shaft; a housing configured to be detachably connected to the moving body and accommodating the nut and the biasing member; and a regulating member provided in the housing and configured to regulate relative rotation of the nut with respect to the housing.

Further features of the present invention will become apparent from the following description of exemplary embodiments (with reference to the attached drawings).

### BRIEF DESCRIPTION OF THE DRAWINGS

FIG. 1 is an external perspective view of a ball screw unit according to an embodiment;

FIG. 2 is an exploded perspective view of the ball screw unit;

FIG. 3 is a cross-sectional view for explaining an internal structure of the ball screw unit;

FIG. 4 is a partially enlarged view of FIG. 3;

FIG. 5A is a side view of a housing;

FIG. 5B is an arrow view of FIG. 5A in a B direction;

FIG. 5C is an arrow view of FIG. 5A in a C direction;

FIG. 5D is a cross-sectional view taken along line II-II of FIG. 5B;

FIG. 6 is a view for explaining a manufacturing process of the ball screw unit;

FIG. 7 is a perspective view schematically illustrating a configuration of a slider unit;

FIG. 8 is a view for explaining a fastening structure for a ball nut, a regulating mechanism, and a slider;

FIG. 9 is an exploded perspective view of a ball screw unit according to an embodiment;

FIG. 10 is a cross-sectional view for explaining an internal structure of the ball screw unit of FIG. 9;

FIG. 11A is a view for explaining a manufacturing process of the ball screw unit;

FIG. 11B is a view for explaining the manufacturing process of the ball screw unit; and

FIG. 12 is a view illustrating a relationship between a groove of a nut and a through hole of a housing.

### DESCRIPTION OF THE EMBODIMENTS

Hereinafter, embodiments will be described in detail with reference to the attached drawings. Note that the following embodiments are not intended to limit the scope of the claimed invention, and limitation is not made to an invention that requires all combinations of features described in the embodiments. Two or more of the multiple features described in the embodiments may be combined as appropriate. Furthermore, the same reference numerals are given to the same or similar configurations, and redundant description thereof is omitted.

### 1. First Embodiment

### 1.1. Ball Screw Unit

### 1.1.1. Overview

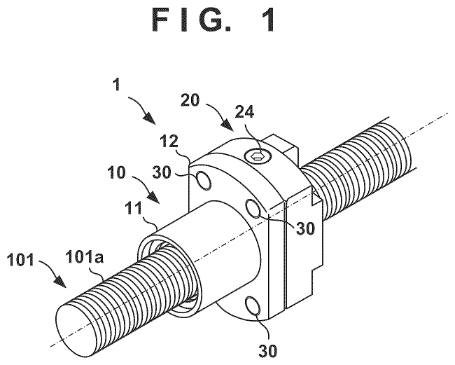

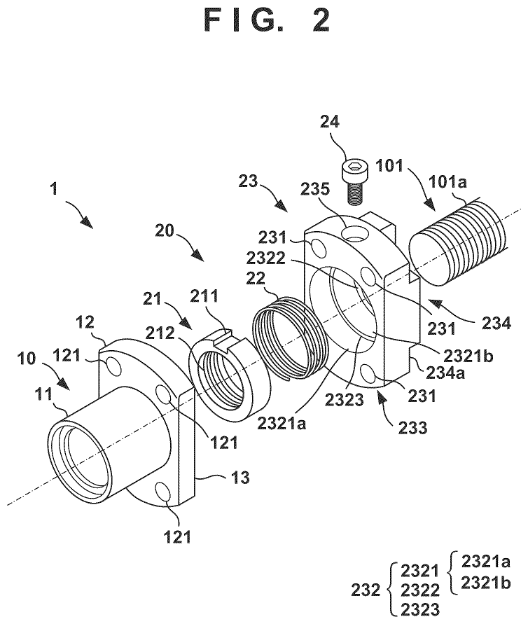

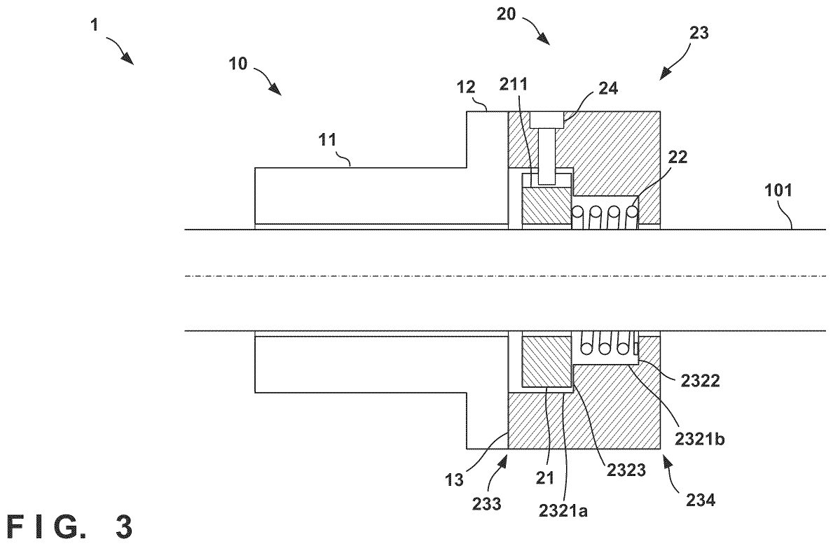

FIG. 1 is an external perspective view of a ball screw unit 1 according to an embodiment. FIG. 2 is an exploded perspective view of the ball screw unit 1. FIG. 3 is a cross-sectional view for explaining an internal structure of the ball screw unit 1. The ball screw unit 1 is a unit to be attached to a screw shaft 101 and movable in the axial direction with respect to the screw shaft 101. The ball screw unit 1 includes a ball nut 10 and a regulating mechanism 20.

### 1.1.2. Ball Nut

The ball nut 10 is an example of a moving body that is movable in the axial direction of the screw shaft 101 (hereinafter, this may be simply referred to as the axial direction) in conjunction with relative rotation with respect to the screw shaft 101. As the ball nut 10, a known mechanism can be employed as appropriate. In the present embodiment, the ball nut 10 includes a main body 11 and a flange 12. The main body 11 is fitted into the screw shaft 101 via a ball (not illustrated). As a result, the rotational motion of the screw shaft 101 is converted into the linear motion of the ball nut 10. In addition, the main body 11 forms a circulation path of the ball (not illustrated).

The flange 12 is formed so as to extend from the main body 11 outwardly in a radial direction of the screw shaft 101 (hereinafter, this may be simply referred to as the radial direction). The flange 12 is formed with a plurality of bolt holes 121 passing in the axial direction. In the general-purpose ball nut 10, an object to be moved (for example, a slider 203 described later) can be attached to the ball nut 10 using the bolt holes 121.

### 1.1.3. Regulating Mechanism

The regulating mechanism 20 regulates the relative rotation of the screw shaft 101 and the ball nut 10. In other words, the regulating mechanism 20 generates a force (braking force) against the movement of the ball nut 10 moving with respect to the screw shaft 101. In the present embodiment, the regulating mechanism 20 is configured to be detachable from the ball nut 10. As will be described in detail later, the regulating mechanism 20 is detachable from the ball nut 10 in which an accommodating space for accommodating the regulating mechanism 20 is not formed. The regulating mechanism 20 includes a housing 23, a nut 21, a coil spring 22, and a screw member 24.

Note that, in the present embodiment, the state in which the relative rotation is regulated by the regulating mechanism 20 may be a state in which the torque required for the relative rotation of the screw shaft 101 and the ball nut 10 is large compared to the case in which the regulating mechanism 20 is not provided. That is, it is sufficient that the braking force for regulating the relative rotation of the screw shaft 101 and the ball nut 10 is generated by the regulating mechanism 20, and the degree of regulation (magnitude of the braking force) by the regulating mechanism 20 can be set as appropriate. For example, in a case in which the ball screw unit 1 is used in such a manner that the axial direction of the screw shaft 101 is the horizontal direction, the relative rotation may be regulated to the extent that inertial motion can be controlled when the moving body including the ball nut 10 is stopped. Alternatively, in a case in which the ball screw unit 1 is used in such a manner that the axial direction of the screw shaft 101 is the vertical direction, the relative rotation may be regulated to the extent that the falling under its own weight can be controlled when the moving body including the ball nut 10 is stopped. In addition, when torque larger than the braking force generated by the regulating mechanism 20 is applied to the screw shaft 101, the screw shaft 101 rotates, and the ball nut 10 moves with respect to the screw shaft 101.

In addition, in the present embodiment, the regulating mechanism 20 is detachable from the ball nut 10, which is an example of the moving body. However, the regulating mechanism 20 may be detachable from another moving body to be moved together with the ball nut 10. For example, in a case in which the ball screw unit 1 is applied to a slider unit U1, which will be described later, the regulating mechanism 20 may be detachable from the slider 203 instead of the ball nut 10. That is, the regulating mechanism 20 is only required to be detachable from a moving body configured to include the ball nut 10.

### (Nut and Coil Spring)

The nut 21 regulates the relative rotation of the screw shaft 101 and the ball nut 10 by a frictional force (braking force) generated between the nut and the screw shaft 101. The nut 21 is a cylindrical member to be fitted to the screw shaft 101, and includes a groove 211 formed on its outer circumferential surface and a screw thread 212 formed on its inner circumferential surface. The groove 211 is formed so as to extend in the axial direction. As will be described in detail later, the relative rotation of the nut 21 and the housing 23 is regulated by inserting the tip of the screw member 24 into the groove 211.

In addition, in the present embodiment, the nut 21 is configured to include a self-lubricating material. For example, the nut 21 is formed using a material impregnated with a lubricating oil. In an embodiment, the nut 21 can contain a resin material. Since the nut 21 is configured to include a self-lubricating material, wear of the nut 21 and the screw shaft 101 can be reduced. In addition, when the nut 21 moves in the axial direction with respect to the screw shaft 101, the lubricant is applied to the screw shaft 101. Accordingly, it is not necessary to provide a member for supplying a lubricant, such as grease, to the ball (not illustrated), and the number of parts is reduced.

The coil spring 22 is an example of a biasing member that biases the nut 21 with respect to the screw shaft 101 so as to generate a frictional force between the nut 21 and the screw shaft 101. As the biasing member, other members such as a leaf spring and a disc spring, which will be described later, can also be employed.

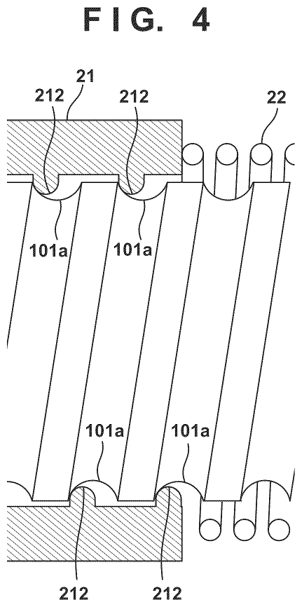

Here, FIG. 4 is a partially enlarged view of FIG. 3, and is a view for explaining the regulation of the relative rotation of the screw shaft 101 and the ball nut 10 by the regulating mechanism 20. When the coil spring 22 biases the nut 21 toward one side in the axial direction, a portion of the screw thread 212 of the nut 21 on one side in the axial direction and a portion of a screw thread 101a of the screw shaft 101 on the other side in the axial direction are brought into contact with each other. As a result, a constant frictional force corresponding to the biasing force of the coil spring 22 is generated between the nut 21 and the screw shaft 101 as a reaction force against the rotation of the screw shaft 101. For example, the regulating mechanism 20 allows the relative rotation of the screw shaft 101 with respect to the nut 21 when torque exceeding the frictional force described above is transmitted from a drive source 202, which will be described later, to the screw shaft 101, and regulates the relative rotation of the screw shaft 101 with respect to the nut 21 when torque less than the frictional force is transmitted to the screw shaft 101.

In the present embodiment, the relative rotation of the ball nut 10 and the screw shaft 101 is regulated by using the nut 21 and the coil spring 22. Therefore, the structure can be simplified and the device can be downsized as compared to a case in which the relative rotation is regulated using an actuator, such as an electromagnetic brake or an air compressor. In addition, in the present embodiment, since the relative rotation is regulated by a mechanical mechanism, energy consumption can be reduced as compared to a case in which an actuator is driven to regulate the relative rotation. Furthermore, the state of relative rotation regulation can be maintained even if power fails due to a power outage at a facility, for example.

In addition, the frictional force between the nut 21 and the screw shaft 101 can be adjusted by adjusting the magnitude of the force (biasing force) with which the coil spring 22 biases the nut 21. That is, the magnitude of the braking force generated by the regulating mechanism 20 can be adjusted by adjusting the magnitude of the biasing force.

### (Housing)

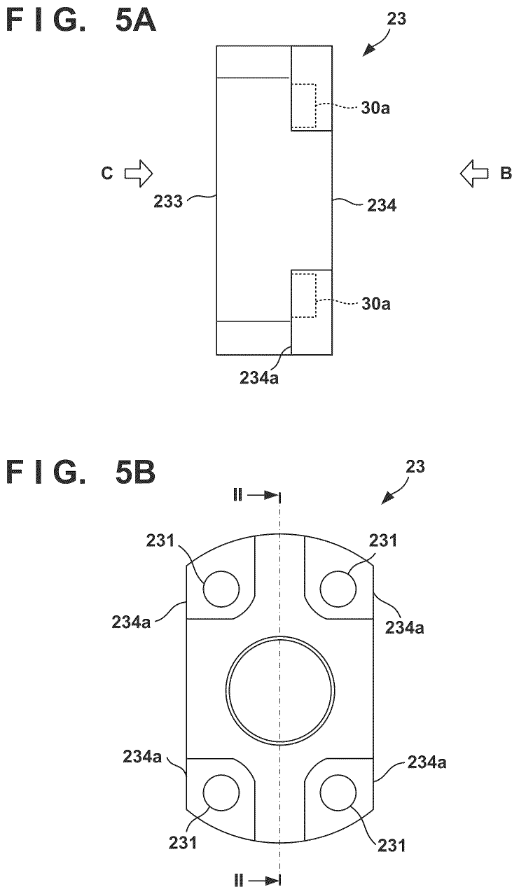

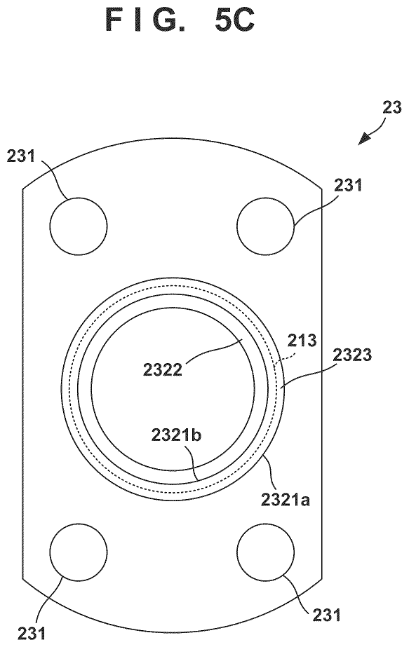

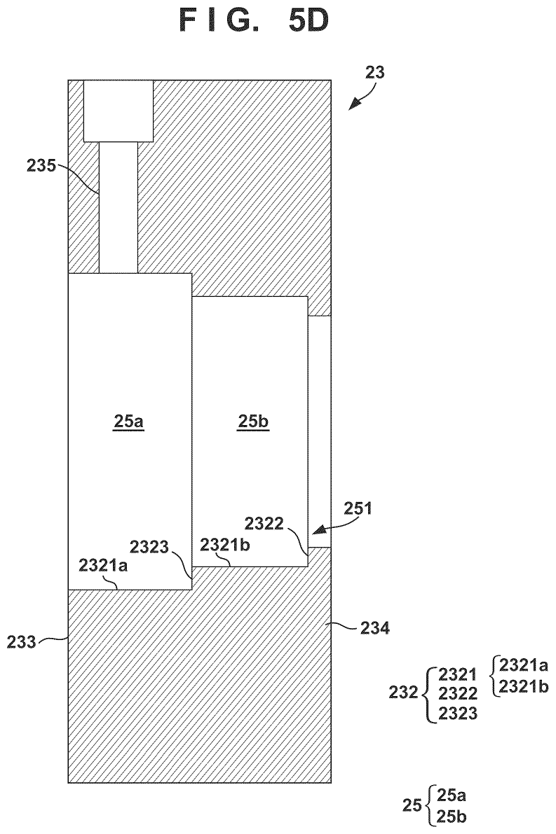

FIGS. 5A to 5D are referred to together with FIGS. 1 to 3. FIG. 5A is a side view of the housing 23. FIG. 5B is an arrow view of FIG. 5A in a B direction. FIG. 5C is an arrow view of FIG. 5A in a C direction. FIG. 5D is a cross-sectional view taken along line II-II of FIG. 5B.

The housing 23 accommodates the nut 21 and the coil spring 22. The housing 23 includes a plurality of bolt holes 231 passing in the axial direction. The bolt holes 231 are an example of a detachable portion to be detachably connected to the ball nut 10. The ball nut 10 and the regulating mechanism 20 are connected by inserting a bolt 30, which is an example of a fastening member, into each bolt hole 121 of the ball nut 10 and each bolt hole 231 of the housing 23 and fastening them. That is, the regulating mechanism 20 is detachable from the ball nut 10 by bolt fastening in a state in which the nut 21 and the coil spring 22 are accommodated. Note that the manner of fastening by the bolt 30 can be changed as appropriate. For example, the ball nut 10 and the housing 23 of the regulating mechanism 20 may be fastened by the bolt 30 and a nut (not illustrated), or a groove to be screwed into the bolt 30 may be formed in either the bolt holes 121 or the bolt holes 231.

In the present embodiment, the regulating mechanism 20 is detachably coupled to an end face 13 of the ball nut 10. Here, the end face 13 is an axial end face of the ball nut 10 formed with an opening into which the screw shaft 101 is to be inserted. In this manner, since the regulating mechanism 20 is detachable from the end face 13 of the ball nut 10, which is an example of the moving body, it is not necessary to form a space for accommodating the components of the regulating mechanism 20 in the ball nut 10. Accordingly, the structure of the ball nut 10 can be simplified.

In addition, the housing 23 includes an end portion 233 and an end portion 234 in the axial direction. The end portion 233 is to be attached to the ball nut 10. Specifically, the end portion 233 is brought into contact with the end face 13 of the ball nut 10 when the ball nut 10 and the regulating mechanism 20 are connected. On the other hand, the end portion 234 is an end portion farther from the ball nut 10 than the end portion 233 in the axial direction. In the present embodiment, the end portion 234 is formed with a recessed portion 234a that is recessed in such a manner that a head portion 30a of the bolt 30 passing through the bolt hole 231 does not protrude in the axial direction with respect to the end portion 234. As a result, since the protrusion and the like of the head portion 30a of the bolt 30 is reduced, the ball screw unit 1 can be downsized in the axial direction. FIG. 5A illustrates the position of the head portion 30a when the bolt 30 is inserted into the bolt hole 231.

In the present embodiment, the bolt holes 231 are disposed so as to overlap the bolt holes 121 of the ball nut 10 as viewed in the axial direction of the screw shaft 101 in a state in which the screw shaft 101 is passed inside the housing 23. Therefore, by using the bolt holes 121 for attaching a member to be moved, which are normally provided in the ball nut 10, the regulating mechanism 20 and the ball nut 10 can be connected. Therefore, the ball nut 10 does not need a dedicated structure for attaching the regulating mechanism 20. That is, the regulating mechanism 20 is detachable from the so-called general-purpose ball nut 10.

The internal structure of the housing 23 is described in detail. The housing 23 includes a wall portion 232 forming an accommodating space 25 accommodating the nut 21 and the coil spring 22. The wall portion 232 includes a circumferential wall portion 2321 forming a side face of the accommodating space 25 and a bottom wall portion 2322 forming one end portion 251 of the accommodating space 25 in the axial direction. The bottom wall portion 2322 is formed so as to extend from the circumferential wall portion 2321 inwardly in the radial direction of the screw shaft 101. Note that, the other end of the accommodating space 25 opposite to the one end portion 251 in the axial direction is partitioned by the end face 13 of the ball nut 10 when the regulating mechanism 20 is connected to the ball nut 10.

In the present embodiment, the coil spring 22 is disposed between the nut 21 and the bottom wall portion 2322. With this arrangement, the bottom wall portion 2322 functions as a bearing face for the coil spring 22. Therefore, since it is not necessary to form a bearing face for the coil spring 22 in the ball nut 10, the structure of the ball nut 10 can be simplified.

In addition, in the present embodiment, the accommodating space 25 includes a nut accommodating portion 25a accommodating the nut 21 and a coil-spring accommodating portion 25b accommodating the coil spring 22. The circumferential wall portion 2321 includes a nut-side circumferential wall portion 2321a forming a side face of the nut accommodating portion 25a and a spring-side circumferential wall portion 2321b forming a side face of the coil-spring accommodating portion 25b. The nut accommodating portion 25a is a space larger than the coil-spring accommodating portion 25b in the radial direction. The nut-side circumferential wall portion 2321a and the spring-side circumferential wall portion 2321b are connected by a connecting wall portion 2323 extending in the radial direction.

In the present embodiment, the nut 21 and the connecting wall portion 2323 overlap each other as viewed in the axial direction of the screw shaft 101. In FIG. 5C, the position of the outer circumferential surface 213 of the nut 21 when the nut 21 is accommodated in the nut accommodating portion 25a is indicated by a dotted line. In the radial direction of the screw shaft 101, the nut 21 is set to a size in which the outer circumferential surface 213 of the nut 21 is positioned inside the nut-side circumferential wall portion 2321a and outside the spring-side circumferential wall portion 2321b. Accordingly, in the direction approaching the end portion 234, the attachment position of the nut 21 to the screw shaft 101 is defined by the connecting wall portion 2323. That is, since the minimum distance between the nut 21 and the bottom wall portion 2322 is defined in the axial direction of the screw shaft 101, the maximum contraction amount of the coil spring 22 can be set as a fixed value.

In addition, in the present embodiment, the contraction amount of the coil spring 22 can be adjusted by adjusting the position of the nut 21 with respect to the nut accommodating portion 25a in the axial direction, and as a result, the magnitude of the braking force generated by the regulating mechanism 20 can be adjusted. Specifically, in the present embodiment, since the nut accommodating portion 25a is larger than the nut 21 in the axial direction, there is a degree of freedom in the arrangement of the nut 21 in the axial direction within the nut accommodating portion 25a. On the other hand, since the nut 21 is screwed into the screw shaft 101 and the rotation is regulated by the screw member 24, the movement in the axial direction is limited within the nut accommodating portion 25a. Specifically, the movement of the nut 21 in the axial direction is limited to a range in which the screw thread 212 of the nut 21 and the screw thread 101a of the screw shaft 101 do not interfere with each other when the nut 21 and the screw shaft 101 do not rotate relative to each other (in other words, a range of backlash of the nut 21 and the screw shaft 101 that are screwed together). Therefore, the contraction amount of the coil spring 22 can be adjusted by positioning the nut 21 at a desired position in the axial direction with respect to the nut accommodating portion 25a at the time of assembling. Furthermore, the contraction amount of the coil spring 22 can be increased as the nut 21 is positioned closer to the coil-spring accommodating portion 25b within the nut accommodating portion 25a, and the contraction amount of the coil spring 22 can be reduced as the nut 21 is positioned closer to the end face 13 of the ball nut 10 within the nut accommodating portion 25a.

Furthermore, in the present embodiment, the entire nut 21 is accommodated in the housing 23 in the axial direction. As a result, it is not necessary to provide a structure (counterbore or the like) for accommodating the components of the regulating mechanism 20 in the ball nut 10. Therefore, since it is not necessary to provide a structure for accommodating the regulating mechanism 20 in the ball nut 10, the structure of the ball nut 10 can be simplified. In addition, since it is not necessary to provide a structure for accommodating the regulating mechanism 20 in the ball nut 10, the regulating mechanism 20 can be easily attached without requiring special machining of the general-purpose ball nut 10.

In addition, the housing 23 is formed with a through hole 235 passing in the radial direction of the screw shaft 101. On the inner surface of the through hole 235, a screw groove into which the screw member 24 is to be screwed is formed.

### (Screw Member)

The screw member 24 is a regulating member that regulates the nut 21 so as to prevent the nut 21 from rotating relative to the housing 23. The screw member 24 is to be screwed into the through hole 235. For example, the screw member 24 may be a hexagon socket set screw or the like. In the present embodiment, by inserting the tip portion of the screw member 24 into the groove 211 in a state in which the screw member 24 is screwed into the through hole 235, the nut 21 can move in the axial direction but is prevented from rotating relative to the housing 23.

Specifically, since the groove 211 is formed along the axial direction, the tip of the screw member 24 does not interfere with the nut 21 when the nut 21 and the housing 23 relatively move in the axial direction. Therefore, the nut 21 and the housing 23 can relatively move in the axial direction. However, in the relationship with the screw shaft 101, the relative movement of the nut 21 in the axial direction is limited to the range of the backlash of the nut 21 and the screw shaft 101 that are screwed together as described above when the relative rotation of the nut 21 and the screw shaft 101 is not involved. Therefore, as a result, the nut 21 can also relatively move in the axial direction with respect to the housing 23 within the range of the backlash of the nut 21 and the screw shaft 101 that are screwed together.

On the other hand, when the nut 21 is to rotate relative to the housing 23, the tip of the screw member 24 is brought into contact with the face of the groove 211 extending in the axial direction and the radial direction. As a result, the relative rotation of the nut 21 with respect to the housing 23 is prevented. In this manner, in the present embodiment, the rotation regulation of the nut 21 can be achieved by a simple configuration using the screw member 24. Note that, in the present embodiment, the screw member 24 prevents the relative rotation of the nut 21 and the housing 23, but the relative rotation may be regulated by another regulating member such as a pin. In this case, the pin may be press-fitted into the through hole 235.

As described above, according to the present embodiment, it is possible to provide a mechanism that generates a force (braking force) against the movement of the ball nut 10 with a simple configuration. In addition, since it is possible to easily attach to the general-purpose ball nut 10, the regulating mechanism 20 can be easily standardized as a distribution component. In addition, the regulating mechanism 20 alone, which is separate from a moving body such as the ball nut 10, can adjust and apply a braking force (biasing force) independently of the moving body.

### 1.2. Method for Manufacturing Ball Screw Unit

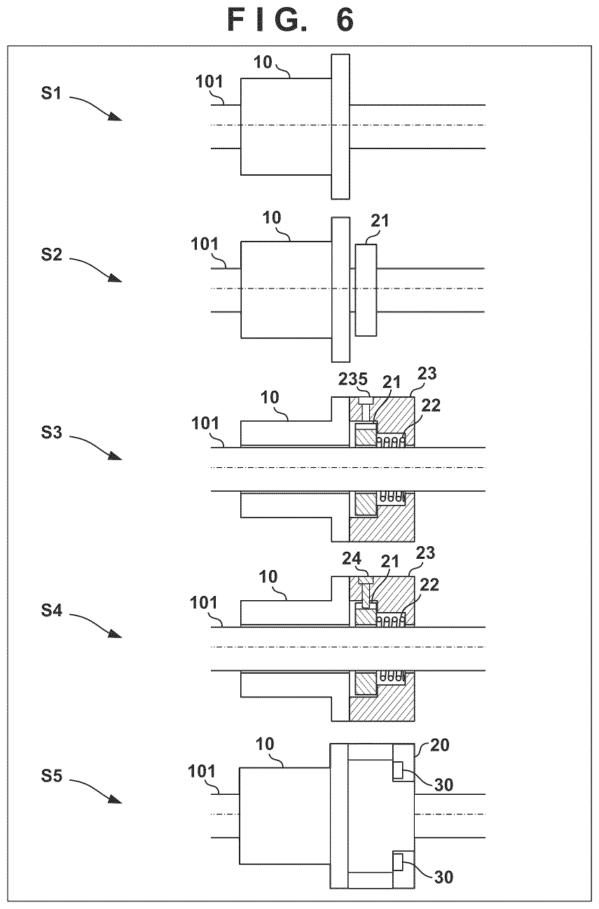

Next, a method for manufacturing the ball screw unit 1 is described. FIG. 6 is a view for explaining a manufacturing process of the ball screw unit 1.

In S1, the ball nut 10, which is an example of the moving body, is assembled to the screw shaft 101. In other words, this is a process of preparing a ball screw including a ball nut and a screw shaft.

In S2, the nut 21 is fitted to the screw shaft 101. In S3, the housing 23 accommodating the coil spring 22, which is an example of the biasing member, is inserted into the screw shaft 101 so that the coil spring 22 biases the nut 21 with respect to the screw shaft 101.

In S4, the nut 21 is regulated by the screw member 24 so as to prevent the nut 21 from rotating relative to the housing 23. That is, the relative rotation of the nut 21 and the housing 23 is regulated by screwing the screw member 24 so as to pass through the through hole 235 and inserting the tip of the screw member 24 into the groove 211 of the nut 21.

In S5, the housing 23 is attached to the ball nut 10. That is, the ball nut 10 and the housing 23 are fastened by the bolt 30.

As described above, in the present embodiment, the regulating mechanism 20 can be easily attached to the ball nut 10.

### 1.3. Slider Unit

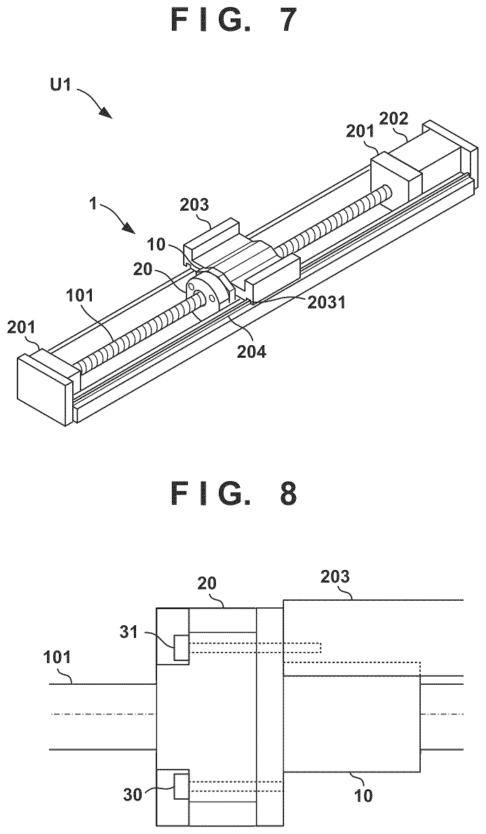

The slider unit U1, which is an application example of the ball screw unit 1, is described. FIG. 7 is a perspective view schematically illustrating a configuration of the slider unit U1.

The slider unit U1 includes the ball screw unit 1, the screw shaft 101, a support portion 201, a drive source 202, a slider 203, and a guide rail 204. Note that the slider unit U1 may be used in such a manner that the moving direction of the slider 203 is a horizontal direction or vertical direction.

The screw shaft 101 is rotatably supported by the support portion 201. The support portion 201 includes, for example, a bearing (not illustrated). The screw shaft 101 rotatably supported by the support portion 201 is rotated by the drive source 202. The drive source 202 is, for example, an electric motor.

In the present embodiment, the ball nut 10 and the slider 203 included in the ball screw unit 1 constitute the moving body. That is, when the screw shaft 101 is rotated by the drive source 202, the ball screw unit 1 and the ball nut 10 integrally move relative to the screw shaft 101 in the axial direction. The slider 203 is a member to be moved by the ball screw unit 1. For example, a table or the like to be used for positioning, transportation, or the like of components can be attached to the slider 203.

The guide rail 204 is a member that guides the slider 203 in linear motion. The slider 203 is formed with a groove 2031 for receiving the guide rail 204.

FIG. 8 is a view for explaining a fastening structure for the ball nut 10, the regulating mechanism 20, and the slider 203. Here, in the present embodiment, the slider 203, the ball nut 10, and the housing 23 of the regulating mechanism 20 are fastened by a common bolt 31. In the so-called general-purpose ball nut 10, the bolt holes 121 for attaching a member to be moved, such as the slider 203, are provided in the flange 12. Therefore, when the regulating mechanism 20 is not provided, the bolt holes 121 and a bolt hole of the slider 203 can be fastened by passing the bolt 31 therethrough. In the present embodiment, by using the bolt holes 121 to also attach the regulating mechanism 20 to the ball nut 10, the regulating mechanism 20 can be attached without increasing the number of bolts as compared to a case in which the regulating mechanism 20 is not provided. In addition, since the slider 203, the ball nut 10, and the regulating mechanism 20 are fastened by the common bolt 31, the bolt holes 231 of the regulating mechanism 20 are disposed so as to overlap the bolt holes 121 of the ball nut 10 when assembled to the screw shaft 101 as viewed in the axial direction.

### 2. Second Embodiment

### 2.1. Ball Screw Unit

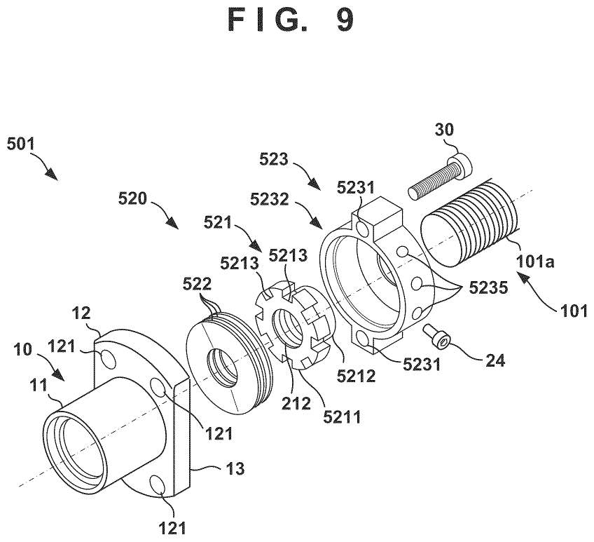

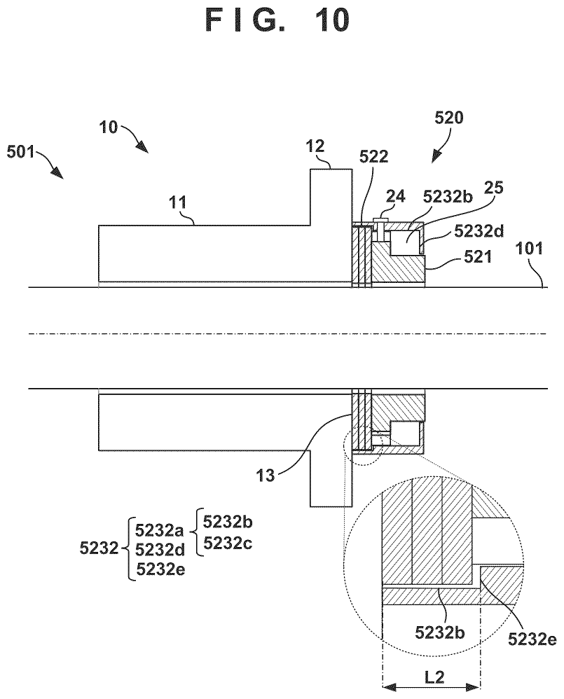

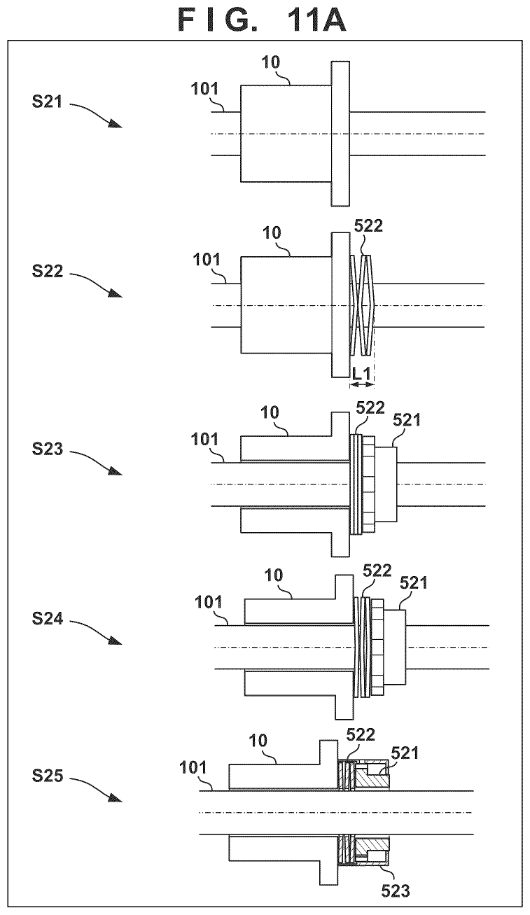

FIG. 9 is an exploded perspective view of a ball screw unit 501 according to an embodiment. FIG. 10 is a cross-sectional view for explaining an internal structure of the ball screw unit 501 of FIG. 9. Hereinafter, the same components as those of the ball screw unit 1 in the first embodiment are denoted by the same reference signs, and the description thereof will be omitted.

The ball screw unit 501 includes the ball nut 10 and a regulating mechanism 520. The regulating mechanism 520 includes a nut 521, a disc spring 522, and a housing 523.

The nut 521 regulates the relative rotation of the screw shaft 101 and the ball nut 10 by the frictional force (braking force) generated between the nut and the screw shaft 101. The nut 521 includes a contact portion 5211, a boss portion 5212, a groove 5213, and a screw thread 212 formed on the inner circumferential surface of the contact portion 5211 and the boss portion 5212.

The contact portion 5211 is a portion to be brought into contact with the disc spring 522. In other words, the contact portion 5211 is a portion that receives a biasing force from the disc spring 522. On the outer circumferential surface of the contact portion 5211, a plurality of grooves 5213 extending in the axial direction of the screw shaft 101 is formed. Each of the grooves 5213 is provided so as to be arranged in the circumferential direction of the screw shaft 101. Although details will be described later (see FIG. 12), the number and arrangement of the grooves 5213 can be changed as appropriate.

The boss portion 5212 is a portion provided so as to extend from the contact portion 5211 in the axial direction. The boss portion 5212 has a smaller diameter than the contact portion 5211. Furthermore, the boss portion 5212 has a smaller diameter than an opening formed in a bottom wall portion 5232d of the housing 523.

The disc spring 522 is an example of a biasing member that biases the nut 521 with respect to the screw shaft 101 so as to generate a frictional force between the nut 521 and the screw shaft 101. For example, the disc spring 522 is formed of a resin material, a metal material, or the like. Although three disc springs 522 are illustrated here, the number of disc springs 522 to be used can be changed as appropriate.

The housing 523 accommodates the nut 521 and the disc springs 522. The housing 523 includes a bolt hole 5231 and a wall portion 5232 forming an accommodating space for the nut 521 and the disc springs 522.

The bolt hole 5231 is an example of a detachable portion detachably connected to the ball nut 10. The ball nut 10 and the regulating mechanism 520 are connected by inserting the bolt 30, which is an example of a fastening member, into the bolt hole 121 of the ball nut 10 and the bolt hole 5231 of the housing 523 and fastening them. In the example of FIG. 9, the bolt holes 5231 are provided in such a manner that the distance between diagonally-arranged two holes of four bolt holes 121 provided in the general-purpose ball nut 10 matches the distance between the two bolt holes 5231 provided in the housing 523. Note that three or more bolt holes 5231 (for example, four bolt holes corresponding to the four bolt holes 121 of the ball nut 10) may be provided in the housing 523. Alternatively, the number, positions, and the like of the bolt holes 121 of the ball nut 10 are not limited to the illustrated example.

The wall portion 5232 includes a side circumferential wall portion 5232a forming a side face of the accommodating space for the nut 521 and the disc springs 522, and a bottom wall portion 5232d forming the one end portion 251 of the accommodating space 25 in the axial direction. The bottom wall portion 5232d is formed so as to extend from the side circumferential wall portion 5232a inwardly in the radial direction of the screw shaft 101. Note that, the other end of the accommodating space 25 opposite to the side on which the bottom wall portion 5232d is provided in the axial direction is partitioned by the end face 13 of the ball nut 10 when the regulating mechanism 520 is connected to the ball nut 10.

The side circumferential wall portion 5232a includes a nut-side circumferential wall portion 5232b forming a side face of a portion of the accommodating space 25 accommodating the nut 521, and a spring-side circumferential wall portion 5232c forming a side face of a portion of the accommodating space 25 accommodating the disc springs 522. The inner circumferential surface of the spring-side circumferential wall portion 5232c is larger than the inner circumferential surface of the nut-side circumferential wall portion 5232b in the radial direction. The nut-side circumferential wall portion 5232b and the spring-side circumferential wall portion 5232c are connected by a connecting wall portion 5232e extending in the radial direction. The connecting wall portion 5232e overlaps the disc springs 522 as viewed in the axial direction. In other words, the connecting wall portion 5232e overlaps the disc springs 522 in the radial direction. As a result, the disc springs 522 can be sandwiched between the end face of the ball nut 10 and the connecting wall portion 5232e.

In addition, the nut-side circumferential wall portion 5232b is provided closer to the bottom wall portion 5232d than the spring-side circumferential wall portion 5232c in the axial direction. Therefore, when the nut 521 and the disc springs 522 are accommodated in the housing 523, the nut 521 is provided between the disc springs 522 and the bottom wall portion 5232d.

In addition, in the present embodiment, the housing 523 is formed with through holes 5235 passing in the radial direction of the screw shaft 101 so as to be arranged in the circumferential direction. On the inner surface of each through hole 5235, a screw groove into which the screw member 24 is to screwed is formed.

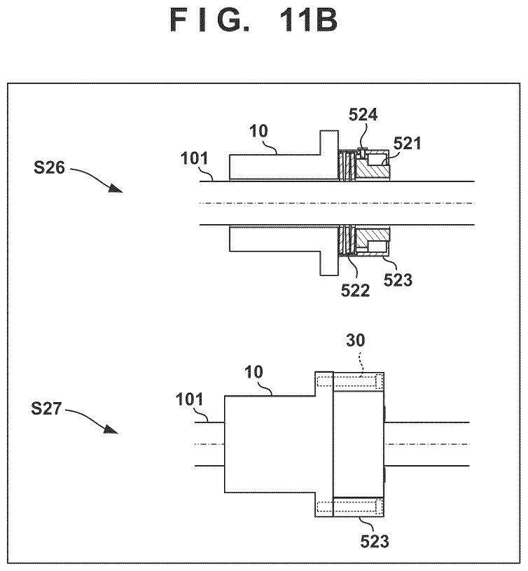

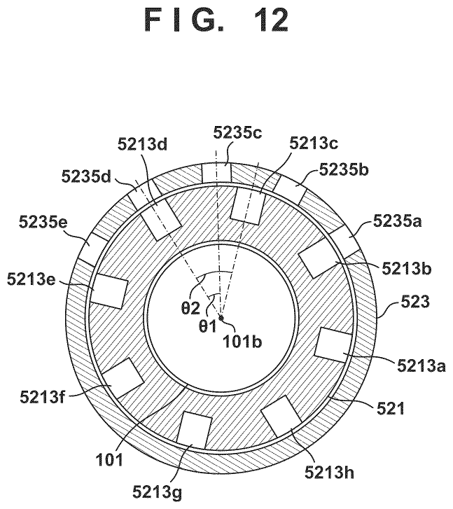

Note that, in the present embodiment, a length L1 before the disc springs 522 are brought into close contact with the ball nut 10 by the nut 521 (that is, the natural length, see FIG. 11A) is longer than an axial length L2 of the spring-side circumferential wall portion 5232c. In addition, the total axial length of the contact portion 5211 and the boss portion 5212 of the nut 521 is substantially the same as the axial length of the nut-side circumferential wall portion 5232b.

The radius of the boss portion 5212 is smaller than the radius of the opening formed in the bottom wall portion 5232d. Therefore, in a state in which the regulating mechanism 520 is assembled to the ball nut 10, the boss portion 5212 is inserted through the opening formed in the bottom wall portion 5232d of the housing 523. As a result, the housing 523 can be downsized while the meshing length between the nut 521 and the screw shaft 101 is secured.

### 2.2. Method for Manufacturing Ball Screw Unit

FIGS. 11A and 11B are views for explaining a manufacturing process of the ball screw unit 501.

In S21, the ball nut 10, which is an example of the moving body, is assembled to the screw shaft 101. In other words, this is a process of preparing a ball screw including a ball nut and a screw shaft.

In S22, the disc spring 522 is assembled to the screw shaft 101.

In S23, the nut 521 is fitted to the screw shaft 101. At this time, by tightening the nut 521 toward the ball nut 10 until the disc springs 522 are brought into close contact with each other, the biasing force of the disc springs 522 is applied to the nut 521.

In S24, the nut 521 is rotated by a predetermined amount to be loosened. This is a process for adjusting the biasing force of the disc springs 522, and the rotation angle of the nut 521 can be adjusted as appropriate.

In S25, the housing 523 is inserted into the screw shaft 101. In S26, the nut 521 is regulated by the screw member 24 so as to prevent the nut 521 from rotating relative to the housing 523. That is, the relative rotation of the nut 521 and the housing 523 is regulated by screwing the screw member 24 so as to pass through the through hole 5235 and inserting the tip of the screw member 24 into the groove 5213 of the nut 521.

Here, in the present embodiment, the nut 521 is provided with a plurality of grooves 5213, and the housing 523 is provided with a plurality of through holes 5235. Then, by inserting the tip of the screw member 24 into any one of the grooves 5213 in a state in which the screw member 24 is screwed into any one of the through holes 5235, the nut 521 is regulated so as to prevent the nut 521 from rotating relative to the housing 523. At this time, in the present embodiment, which through hole 5235 and which groove 5213 are used can be selected as appropriate according to the positional relationship between the nut 521 and the housing 523 in the circumferential direction. This is described in detail below. FIG. 12 is a view for explaining a relationship between the grooves 5213 of the nut 521 and the through holes 5235 of the housing 523. In the present embodiment, the grooves 5213 (grooves 5213a to 5213h) arranged in the circumferential direction are formed on the outer circumferential surface of the nut 521. In addition, the through holes 5235 (through holes 5235a to 5235e) arranged in the circumferential direction are formed in the housing 523. In the state of FIG. 12, the through hole 5235c and the groove 5213d overlap in the circumferential direction. Therefore, by screwing the screw member 524 into the through hole 5235c and inserting the tip of the screw member 524 into the groove 5213d, the relative rotation of the nut 521 and the housing 523 is regulated.

In addition, in the present embodiment, a central angle θ1 formed by the adjacent grooves 5213c and 5213d and a central axis 101b of the screw shaft 101 is different from a central angle θ2 formed by the adjacent through holes 5235b and 5235c and the central axis 101b. As a result, when the housing 523 is inserted into the screw shaft 101, the grooves 5213 and the through holes 5235 easily overlap each other in the circumferential direction. Therefore, the relative rotation of the nut 521 and the housing 523 can be more easily regulated. For example, in a case of the central angle θ1=30° and the central angle θ2=45°, any one of the grooves 5213 and any one of the through hole 5235 overlap each other every 15°. Therefore, the position of the nut 521 can be defined in 15° increments. On the other hand, since the intervals between the grooves 5213 and between the through holes 5235 is larger than those in a case of the central angle θ1=θ2=15°, it is possible to reduce the deterioration in strength of the nut 521 and the housing 523.

Note that the number of the grooves 5213, the central angle θ1, the number of the through holes 5235, and the central angle θ2 can be designed as appropriate. In addition, the intervals between the grooves 5213 and between the through holes 5235 may not be uniform. In other words, the central angle formed by two adjacent grooves of the grooves 5213 and the central axis 101b may not be constant, and the central angle formed by two adjacent holes of the through holes 5235 and the central axis 101b may not be constant.

In S27, the housing 523 is attached to the ball nut 10. That is, the ball nut 10 and the housing 523 are fastened by the bolt 30.

### 3. Other Embodiments

The ball screw unit 1 is applicable not only to the slider unit U1 but also to other units. For example, the ball screw unit 1 can be used to open and close a vacuum gate valve. In this case, the free fall of the ball nut 10 can be controlled by using the regulating mechanism 20.

While an embodiment has been described, the invention is not limited to the foregoing embodiments, and various variations/changes are possible within the spirit of the invention.

What is claimed is:

1. A ball screw unit configured to be attached to a screw shaft, comprising:
a moving body configured to be movable in an axial direction of the screw shaft in conjunction with relative rotation with the screw shaft; and
a regulating mechanism configured to regulate the relative rotation of the screw shaft and the moving body, wherein
the regulating mechanism includes:
a nut to be screwed into the screw shaft;
a biasing member configured to bias the nut in the axial direction so as to generate a frictional force between the nut and the screw shaft;
a housing configured to be detachably connected to the moving body and accommodating the nut and the biasing member; and
a regulating member provided in the housing and configured to regulate relative rotation of the nut with respect to the housing.

2. The ball screw unit according to claim 1, wherein
the moving body includes an end face in the axial direction formed with an opening into which the screw shaft is to be inserted, and
the housing includes a detachable portion configured to be detachably coupled to the end face of the moving body.

3. The ball screw unit according to claim 1, wherein
the moving body and the housing are fastened by a fastening member,
the housing includes a wall portion forming an accommodating space accommodating the nut and the biasing member, and
the wall portion includes:
a circumferential wall portion forming a side face of the accommodating space; and
a bottom wall portion forming one end portion of the accommodating space in the axial direction,
the regulating member is a screw member to be screwed into the through hole, and
the nut is entirely accommodated in the housing in the axial direction, and
the screw member is provided with the housing so as to regulate relative rotation of the nut with regard to the housing.

4. The ball screw unit according to claim 1, wherein
the nut is configured to include a self-lubricating material, and
a lubricant is applied to the screw shaft form the nut when the nut moves in the axial direction with respect to the screw shaft.

5. The ball screw unit according to claim 1, wherein
the housing includes a wall portion forming an accommodating space accommodating the nut and the biasing member, and
the wall portion includes:
a circumferential wall portion forming a side face of the accommodating space; and
a bottom wall portion forming one end portion of the accommodating space in the axial direction, and
the circumferential wall portion includes:
a first circumferential wall portion forming a side face of a first accommodating space accommodating the nut; and
a second circumferential wall portion forming a side face of a second accommodating space accommodating the biasing member,
the wall portion includes a connecting wall portion extending in a radial direction of the screw shaft so as to connect the first circumferential wall portion and the second circumferential wall portion, and
the connecting wall portion is configured to define an attachment position of the nut to the screw shaft in a direction approaching the bottom wall portion.

6. The ball screw unit according to claim 1, wherein
the housing includes a wall portion forming an accommodating space accommodating the nut and the biasing member, and
the wall portion includes:
a circumferential wall portion forming a side face of the accommodating space; and
a bottom wall portion forming one end portion of the accommodating space in the axial direction, and
the nut is disposed between the biasing member and the bottom wall portion.

7. The ball screw unit according to claim 1, wherein
the nut includes a groove extending in the axial direction formed on an outer circumferential surface,
the housing is formed with a through hole passing in a radial direction of the screw shaft,
the regulating member is a screw member to be screwed into the through hole, and
the nut is movable in the axial direction while relative rotation with respect to the housing is regulated by inserting a tip portion of the regulating member into the groove in a state in which the regulating member is screwed into the through hole.

8. The ball screw unit according to claim 1, wherein
the nut includes a plurality of grooves extending in the axial direction of the screw shaft formed on an outer circumferential surface of the nut so as to be arranged in a circumferential direction of the screw shaft,
the housing includes a plurality of through holes passing in a radial direction of the screw shaft formed so as to be arranged in the circumferential direction,
the regulating member is a screw member to be screwed into any one of the plurality of through holes,
the nut is movable in the axial direction while relative rotation with respect to the housing is regulated by inserting a tip portion of the regulating member into any one of the plurality of grooves in a state in which the regulating member is screwed into any one of the plurality of the through holes, and
a first central angle defined by two adjacent grooves of the plurality of grooves arranged in the circumferential direction and a central axis of the screw shaft is different from a second central angle defined by two adjacent through holes of the plurality of through holes arranged in the circumferential direction and the central axis.

9. The ball screw unit according to claim 1, wherein
the nut includes:
a contact portion configured to be brought into contact with the biasing member; and
a boss portion extending from the contact portion in the axial direction of the screw shaft, and
at least a part of the boss portion enters, in a state in which the ball screw unit is assembled to the screw shaft, an opening formed in the bottom wall portion through which the screw shaft passes.

10. The ball screw unit according to claim 1, wherein
the nut includes:
an inner circumferential surface formed with a screw thread to be screwed into a screw thread of the screw shaft; and
an outer circumferential surface provided with a groove into which the regulating member is inserted, and
the relative rotation of the nut with respect to the housing is regulated by the groove and the regulating member, while relative movement of the nut with respect to the housing in the axial direction is not regulated.

11. The ball screw unit according to claim 1, wherein
the regulating mechanism is configured to adjust a biasing force of the biasing member with respect to the nut.

12. A slider unit comprising:
a ball screw unit;
a screw shaft to be inserted into the ball screw unit; and
a support portion rotatably supporting the screw shaft, wherein
the ball screw unit includes:
a moving body movable in an axial direction of the screw shaft in conjunction with relative rotation with the screw shaft; and
a regulating mechanism configured to regulate the relative rotation of the screw shaft and the moving body, and
the regulating mechanism includes:
a nut to be screwed into the screw shaft;
a biasing member configured to bias the nut in the axial direction so as to generate a frictional force between the nut and the screw shaft;
a housing configured to be detachably connected to the moving body and accommodating the nut and the biasing member; and
a regulating member provided in the housing and configured to regulate relative rotation of the nut with respect to the housing.

13. The slider unit according to claim 12, wherein
the moving body includes:
a first moving body; and
a second moving body, and
the first moving body, the second moving body, and the regulating mechanism are fastened by a common bolt.

14. The slider unit according to claim 12, further comprising:
a drive source configured to rotate the screw shaft, wherein
the relative rotation of the screw shaft with respect to the nut is allowed when torque exceeding the frictional force is transmitted from the drive source to the screw shaft, and
the relative rotation of the screw shaft with respect to the nut is regulated when torque less than the frictional force is transmitted from the drive source to the screw shaft.

15. A regulating unit applicable to a ball screw including a screw shaft and a moving body movable in an axial direction of the screw shaft in conjunction with relative rotation with the screw shaft, and configured to regulate the relative rotation of the screw shaft and the moving body, the regulating unit comprising:
a nut configured to be fitted to the screw shaft;
a biasing member configured to bias the nut in the axial direction so as to generate a frictional force between the nut and the screw shaft;
a housing configured to be detachably connected to the moving body and accommodating the nut and the biasing member; and
a regulating member provided in the housing and configured to regulate relative rotation of the nut with respect to the housing.

16. The regulating unit according to claim 15, wherein
the nut is configured to include a self-lubricating material, and
a lubricant is applied to the screw shaft form the nut when the nut moves in the axial direction with respect to the screw shaft.

17. The regulating unit according to claim 15, wherein
the moving body and the housing are fastened by a fastening member,
the housing includes a wall portion forming an accommodating space accommodating the nut and the biasing member, and
the wall portion includes:
a circumferential wall portion forming a side face of the accommodating space; and
a bottom wall portion forming one end portion of the accommodating space in the axial direction,
the regulating member is a screw member to be screwed into the through hole, and
the nut is entirely accommodated in the housing in the axial direction, and
the screw member is provided with the housing so as to regulate relative rotation of the nut with regard to the housing.

18. The regulating unit according to claim 15, wherein
the housing includes a wall portion forming an accommodating space accommodating the nut and the biasing member, and
the wall portion includes:
a circumferential wall portion forming a side face of the accommodating space; and
a bottom wall portion forming one end portion of the accommodating space in the axial direction,
the circumferential wall portion includes:
a first circumferential wall portion forming a side face of a first accommodating space accommodating the nut; and
a second circumferential wall portion forming a side face of a second accommodating space accommodating the biasing member,
the wall portion includes a connecting wall portion extending in a radial direction of the screw shaft so as to connect the first circumferential wall portion and the second circumferential wall portion, and
the connecting wall portion is configured to define an attachment position of the nut to the screw shaft in a direction approaching the bottom wall portion.

19. The regulating unit according to claim 15, wherein
the housing includes a wall portion forming an accommodating space accommodating the nut and the biasing member, and
the wall portion includes:
a circumferential wall portion forming a side face of the accommodating space; and
a bottom wall portion forming one end portion of the accommodating space in the axial direction, and
the nut is disposed between the biasing member and the bottom wall portion.

20. The regulating unit according to claim 15, wherein
the nut includes a groove extending in the axial direction formed on an outer circumferential surface,
the housing includes a through hole passing in a radial direction of the screw shaft,
the regulating member is a screw member to be screwed into the through hole, and
the nut is movable in the axial direction while relative rotation with respect to the housing is regulated by inserting a tip portion of the regulating member into the groove in a state in which the regulating member is screwed into the through hole.

21. The regulating unit according to claim 15, wherein
the nut includes a plurality of grooves extending in the axial direction of the screw shaft formed on an outer circumferential surface of the nut so as to be arranged in a circumferential direction of the screw shaft,
the housing includes a plurality of through holes passing in a radial direction of the screw shaft formed so as to be arranged in the circumferential direction,
the regulating member is a screw member to be screwed into any one of the plurality of through holes,
the nut is movable in the axial direction while relative rotation with respect to the housing is regulated by inserting a tip portion of the regulating member into any one of the plurality of grooves in a state in which the regulating member is screwed into any one of the plurality of the through holes, and
a first central angle defined by two adjacent grooves of the plurality of grooves arranged in the circumferential direction and a central axis of the screw shaft is different from a second central angle defined by two adjacent through holes of the plurality of through holes arranged in the circumferential direction and the central axis.

22. The regulating unit according to claim 15, wherein
the nut includes:
a contact portion configured to be brought into contact with the biasing member; and
a boss portion extending from the contact portion in the axial direction of the screw shaft, and
at least a part of the boss portion enters, in a state in which the ball screw is assembled to the screw shaft, an opening formed in the bottom wall portion through which the screw shaft passes.

23. The regulating unit according to claim 15, wherein
the nut includes:
an inner circumferential surface formed with a screw thread to be screwed into a screw thread of the screw shaft; and
an outer circumferential surface provided with a groove into which the regulating member is inserted, and
the relative rotation of the nut with respect to the housing is regulated by the groove and the regulating member, while relative movement of the nut with respect to the housing in the axial direction is not regulated.
